(19) United States
(12) Patent Application Publication
(10) Pub. No.: US 2018/0272856 A1
(43) Pub. Date: Sep. 27, 2018

(54) Ducted Fan Propulsion System

(71) Applicant: Kerry Manning, Parker, CO (US)

(72) Inventor: Kerry Manning, Parker, CO (US)

(21) Appl. No.: 15/761,802

(22) PCT Filed: Sep. 16, 2016
(86) PCT No.: PCT/US16/52208

§ 371 Date: Mar. 20, 2018

Related U.S. Application Data
(60) Provisional application No. 62/221,037, filed on Sep. 20, 2015.

(51) Int. Cl. B60K 8/00; B64C 39/02

(52) U.S. Cl. CPC B60K 8/00; B64C 2201/108; B64C 39/024

(57) ABSTRACT

In an embodiment, a ducted fan propulsion system comprises an outer cowling, adapted to form a duct. The duct houses one or more fan blades rotating about a central axis. One or more motors are in communication with the fan blades and in communication with a power source. The duct is transversed by a plurality of spokes. In an embodiment, multiple ducts are housed within an outer cowling, with each duct comprising one or more rotatable fan blades, one or more central axes, and one or more motors. In each embodiment, one or more members are attached to the ducted or multi-ducted fan propulsion system and extend to a user or vehicle. The members terminate in a handle further comprising a throttle adjuster.

### CROSS-REFERENCE TO RELATED APPLICATION(S)

The present application claims priority to U.S. Provisional Patent Application No. 62/221,037 filed on Sep. 20, 2015, entitled “Ducted fan propulsion system”; and PCT Application No. PCT/US16/52208 filed on Sep. 16, 2016, entitled “DUCTED FAN PROPULSION SYSTEM”, the entire disclosures of which are incorporated by reference herein.

### BACKGROUND OF THE INVENTION

### 1. Field of Invention

The present disclosure relates, in general, to the use of fans to provide thrust for transportation systems and enabling component designs.

### 2. Description of Related Art

New developments in small lightweight electric motors have enabled new potential propulsion configurations for small vehicles. While the main focus of this system is a ducted fans system for powering small ground vehicles the system is also applicable to aircraft, ground effect vehicles, manned or unmanned drones, water-based vehicles or personnel systems that require no vehicle at all. While current electric motors have very high power to weight ratios the associated power supplies, batteries and/or generator are much heavier and bulkier. Also, current propeller and ducted fan systems are fragile and potentially dangerous. This system is applicable whether the fan is used to provide propulsive thrust or vertical lift.

Throughout recent history, a number of locomotion devices have been invented in which fan blades, or a similar device is used as the driving force of the vehicle. For example, airboats are a common means of moving about a shallow waterway which a motor would either cause the vessel to bottom out, or pick up too much debris from the water. The watercraft uses an aircraft-type propeller combined with a flat bottom flotation surface to propel passengers over water. The advantage of the vessel lies in the fact that there are no operating parts below the waterline. The propeller results in a prop wash directing a rearward column of air. Steering is accomplished by diverting that rearward traveling column of air with rudders.

Safety is a major concern for airboats as well as other vehicles that rely on propellers for propulsion. A metal cage that prevents objects from coming in contact with the whirling propeller encloses the propeller.

A more practical use of fan propulsion technology is seen in the recent increase of multi-rotor copters. A ducted fan in many applications such as personnel vehicles or multi-rotor copters (such as a quad copter) are placed at the extremities and as such are subject to damage. The ducted fans are typically not very durable being made from composites or aluminum and require a tight clearance between the rotor blades and the inner duct housing. Any deformation (either elastic or permanent) will likely result in contact of the rotor and housing resulting in a catastrophic loss of the fan. To mitigate this, the fans outer housing, referred to as a cowling is designed with protection in mind.

Typically, the motor is restrained in the center of the duct restricting its movement about the duct. This construction ensures the fan blades do not come in contact with the duct in a damaging manner.

Present designs are either too small and underpowered to be used as a Personal Air Propulsion System, herein referred to as PAPS, or to bulky requiring far too big of a device to be convenient in most applications. The propelling device of Burgess U.S. application Ser. No. 13/657,113 discloses a device mounted on the back of a user. Unfortunately, the device is in close proximity to the user and provides little safety features which may prevent limbs, or debris from entering the fan duct. Further, the thrust of the device is not completely modular, in that the thrust expelled is not omnidirectional. The device is not meant to attach to a variety of application and be completely modular by a user or computer once in use.

Based on the foregoing, there is a need in the art for a lightweight design of a ducted fan propulsion which may be utilized in a wide range of applications.

### SUMMARY OF THE INVENTION

In an embodiment, a ducted fan propulsion system comprises an outer cowling adapted to form a duct. The duct is adapted for the intake and expulsion of air to create thrust. One or more rotatable fan blades are positioned within the duct and are rotatable about a central axis. The fan blades are in communication with and powered by one or more motors. The outer cowling, fan blade, motor, and other components are connected to a user by one or members. Each motor is in communication with one or more power sources, in an embodiment, each power source is external such to allow the overall weight of the device to be reduced. In a particular embodiment, an inner duct is positioned within the outer cowling to provide a rigid structure within the duct.

In an embodiment, a plurality of spokes transverse the duct between the outer cowling and central axis.

In an embodiment, the outer cowling is adapted to be inflatable. In further embodiments, the outer cowling may be made of foam, foam beads, or other materials known in the art to be lightweight.

In an embodiment, one or more members are connecting the ducted fan propulsion system and a vehicle. The ducted fan propulsion system is adapted to impart thrust on the user, vehicle, or other body.

In an embodiment, the one or more members further comprise; one or more steering cables, one or more drag cables, and one or more power cables, in communication with the ducted fan propulsion system and a user, vehicle, power source, or other body. Further, one or more members is in communication with one or more handles which further comprise a throttle adjuster.

In an embodiment, one or more members are rigid and in communication with the ducted fan propulsion system and user or vehicle.

In an embodiment, the handle comprises a mounted display.

In an embodiment, the ducted fan propulsion system comprises a connection arm, adapted to connect one or more ducted fan propulsion systems.

In an embodiment, the ducted fan propulsion system is a multi-ducted fan propulsion system, comprising an outer cowling adapted to form a multitude of ducts within the outer cowling. Each duct comprises one or more rotatable fan blades positions about one or more central axes. Each fan blade is in communication with one or more motors which are in communication with one or more power sources. The multi-ducted fan propulsion system is in communication with a user, or vehicle by one or more members.

In an embodiment, a plurality of spokes transverse each duct in connection with the outer cowling and central axes.

In an embodiment, each duct comprises two apertures, one aperture adapted to intake air, and a second aperture adapted to expel air at the opposing end of the first aperture.

In an embodiment, an inner duct is positioned within the outer cowling forming a rigid structure within one or more ducts and providing further protection to one or more ducts.

In an embodiment, the outer cowling is hollow and adapted to be inflatable. In an alternate embodiment, the outer cowling is made of foam or other lightweight material known in the art.

In an embodiment, the one or more members further comprise one or more steering cables, one or more drag cables, and one or more power cables. In an embodiment, one or more members are in communication with one or more handles. In a particular embodiment, one or more handles comprise a throttle adjuster. In a further embodiment, one or more handles comprise a display.

In a particular embodiment, the multi-ducted fan propulsion system is in communication with, and controllable by a computer.

In an embodiment, the multiple multi-ducted fan propulsion systems are connected by a connection arm.

The foregoing, and other features and advantages of the invention, will be apparent from the following, more particular description of the preferred embodiments of the invention, the accompanying drawings, and the claims.

### BRIEF DESCRIPTION OF THE DRAWINGS

For a more complete understanding of the present invention, the objects and advantages thereof, reference is now made to the ensuing descriptions taken in connection with the accompanying drawings briefly described as follows.

FIG. 1 is a cross section of the personal air propulsion system, according to an embodiment of the present invention;

FIG. 2 is a front view of the personal air propulsion system, according to an embodiment of the present invention;

FIG. 3A is a perspective view of the personal air propulsion system, according to an embodiment of the present invention;

FIG. 3B is a perspective view of the personal air propulsion system, according to an embodiment of the present invention;

FIG. 3C is a perspective view of the personal air propulsion system, according to an embodiment of the present invention;

FIG. 4A is a perspective view of the personal air propulsion system, according to an embodiment of the present invention;

FIG. 4B is a perspective view of the personal air propulsion system, according to an embodiment of the present invention;

FIG. 5A is a perspective view of the personal air propulsion system, according to an embodiment of the present invention;

FIG. 5B is a perspective view of the personal air propulsion system, according to an embodiment of the present invention;

FIG. 6A is a perspective view of the personal air propulsion system, according to an embodiment of the present invention;

FIG. 6B is a perspective view of the personal air propulsion system, according to an embodiment of the present invention;

FIG. 7 is a perspective view of the personal air propulsion system, according to an embodiment of the present invention;

FIG. 8A is a perspective view of the personal air propulsion system, according to an embodiment of the present invention;

FIG. 8B is a perspective view of the personal air propulsion system, according to an embodiment of the present invention;

FIG. 8C is a perspective view of the personal air propulsion system, according to an embodiment of the present invention;

FIG. 9 is a perspective view of the personal air propulsion system, according to an embodiment of the present invention;

FIG. 10A is a perspective view of the personal air propulsion system, according to an embodiment of the present invention;

FIG. 10B is a perspective view of the personal air propulsion system, according to an embodiment of the present invention;

FIG. 11A is a perspective view of the personal air propulsion system, according to an embodiment of the present invention;

FIG. 11B is a perspective view of the personal air propulsion system, according to an embodiment of the present invention;

FIG. 11C is a perspective view of the personal air propulsion system, according to an embodiment of the present invention;

FIG. 12A is a perspective view of the personal air propulsion system, according to an embodiment of the present invention;

FIG. 12B is a perspective view of the personal air propulsion system, according to an embodiment of the present invention; and

FIG. 13 is a perspective view of the personal air propulsion system, according to an embodiment of the present invention.

### DETAILED DESCRIPTION OF PREFERRED EMBODIMENTS

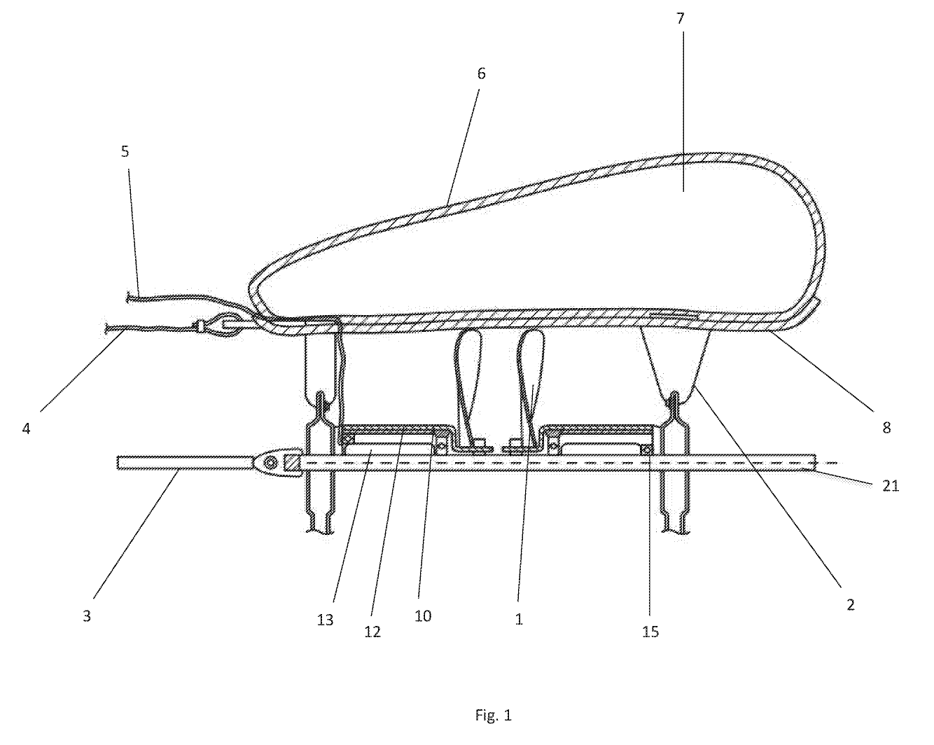

Preferred embodiments of the present invention and their advantages may be understood by referring to FIGS. 1-13, wherein like reference numerals refer to like elements.

In the simplest embodiment the fan assembly consists of a round rigid tube that holds the fan and serves as the inner duct that is surrounded with a plastic tube that is inflated with relatively low pressure in order to form the desired aerodynamic shape, such as a large radius at the duct intake, and provide the desired impact protection.

In small lightweight motors this is inflated with a low-density gas (such as helium) that will decrease the effective weight. While the displaced air may not be sufficient to make the unit positively or even neutrally buoyant it can help to decrease the rate of impact in the case of a power failure.

Typically, the motor is restrained in the center of the inner duct with rigid elements that are essential in maintaining the small rotor to duct clearance, which is critical to efficient operation. One embodiment uses spoke like elements to restrain the motor/rotor assembly. These spokes could be oriented in several configurations depending on the application. When they are all located on axial plane they are best configured for maintaining the rotor clearance. By angling the spokes from that plane, the spokes can also react the thrust and gyroscopic loads. Furthermore, the spokes could be located on multiple planes to provide a very stiff connection but also to act as a safety net to prevent objects (sticks, hands, etc) from contacting the blades. This would be advantageous over a conventional support system as the motor support and safety net are combined reducing drag, weight and part count while still retaining safety.

This ducted fan assembly could be applied to current conventional designs such as small remotely operated quadcopters but also manned vehicles and enables a new application of providing a Personal Air Propulsion System herein referred to as (PAPS).

One embodiment of the ducted fan is the Personal Air Propulsion System (PAPS) in which an individual(s) is propelled by an electric ducted fan that is light and maneuverable such that it can be pointed and controlled in the hands of an individual. This is accomplished by keeping the typically heavy energy source (such as a lithium battery pack or micro generator) separate from the propulsion assembly.

In an embodiment, one or more members, or power wires and/or fuel wires are combined with one or more drag wires. This design simplifies the device while retaining and even improving functionality. In a particular embodiment, cables may be made of aluminum or other low resistance material to transfer electrical energy to the motor.

This power pack could be a battery pack that is worn like a backpack or vest, or one that is mounted to a vehicle. In the case of a backpack or vest set-up the pack may have an integrated harness system so that it can transfer the thrust of the fans into the person or persons.

The PAPS is intended to be used with small personal vehicles including but not limited to: kayak, surfboard, skies, snowboard, canoe, skated board, roller blades, karts, wake board, etc. In one embodiment the power pack is used with no vehicle modifications making a single system easily transferable between different vehicles and applications but also maybe integrated directly into the vehicle.

In use, the fan ducted fan system is connected to a user by utilizing one or more connection components such as a drag wire and steering cables. One or more drag wires and one or more steering cables may be combined in order to serve the dual purpose of transferring the force generated by the ducted fan assembly to the user, as well as transfer power or fuel from a storage device to one or more motors.

Each connection component may be used to control the direction of the thrust. This is accomplished by pointing the ducted fan assembly in the desired direction. The user, for example, may do this manually by pulling one or more connection component. In an embodiment, a computer may be used to control the connection components.

In an embodiment, control may also or in addition, be achieved by applying varying thrust or counter-thrust to one or more fans in the ducted fan assembly. This function may be controlled by a user or by a computer. For example, in a multiple ducted fan assembly, one or more fans may be adjusted such that the thrust emitted is less than another, causing the assembly to turn.

Power to the fans is achieved by the transmittal of electrical energy from one or more external power sources such as batteries, to one or more motors of the fan assembly. Power cables may travel from the external battery to the motor independently or be integrated into one or more of the drag cables, steering cables, or other connecting components.

To anyone trained in the state of the art it would be seen that all or pan of the design of this ducted fan assembly can be of great benefit in many different applications requiring thrust. While this concept is focused on the application of a personal propulsion system the fan assembly has significant advantages for weight, cost, simplicity, durability, adaptability, and safety that can be directly applied to other systems. This would include the use of the ducted fan design as a primarily lifting device, in addition to the primarily propulsive use described herein. This lifting application is particularly ideal for drones where the safety of bystanders is of utmost importance as well as protecting the craft from damage in the inevitable crashes that occur. This could include everything from a single ducted fan with secondary controls to the ubiquitous, quad-copters, octo-copters and the like. In one embodiment the computer-controlled fan assembly is used in primarily a lifting mode to hover with the payload supported from the cables as opposed to providing trust to an individual. Just like in the personal propulsion application the orientation of the duct, and the use of additional ducted fans can provide lift, horizontal thrust, or a combination there of. Likewise, the personal propulsion application of the ducted fan design could be primarily for providing lift in a manned ground effect or VTOL (Vertical Take Off and Landing) craft such as in a hoverbike or flying car with the same potential advantages of weight, cost, simplicity, durability, adaptability, and safety.

One knowledgeable in the art will observe that the concepts described herein can be combined in many permutations which would be impractical to list and should not be limited to the embodiments described below.

In reference to FIG. 1, a cross section of the design is shown. In its simplest form, the design comprises one or more, but at least one set of fan blades 1 rotating about a central axis 21. The fan blades 1 are positioned to propel the PAPS by moving air through a cylindrical duct. The function of the cylindrical duct is to reduce the loss of thrust from the tips of the fan blades 1 as seen in traditional propellers. Each set of fan blades are powered by an electrical motor 10, and each electrical motor 10 comprises a series of magnets and/or windings 12, providing the magnetic field necessary to provide rotational force. The essential purpose of the motor is to convert electrical energy to potential energy needed to propel the device. As shown in FIG. 1, a preferred embodiment of two fan blades 1 rotate around a common shaft. The bearings allow for the motor and fans to rotate relative to the non-rotating duct and spoke and even the fans rotate independently of each other. The use of a single common shaft is preferred as the single shaft resolves all radial loads to two points in shear, so that those points—in this case the spokes—do not have to react to bending loads.

In a preferred embodiment the motor utilized is a Brush-Less Direct Current motor, however, any specific motor type may be implemented as seen fit. In alternative embodiments, the fan blades 1 may be powered by a turbine, engine, or other high density energy source known in the art.

In a preferred embodiment, the fan blades 1 and an inner duct 8 have as close to the same distance from the central axis 21 as possible without the fan blade 1 coming in contact with the inner duct 8. The inner duct is made from a hard, resilient surface to maintain the proper aerodynamic shape and protect against bending in the case that the device is impacted. This rigid construction further ensures the safety of the device and prevents catastrophic failure. In design, the inner duct 8 is a cylinder with apertures at each of two ends, adapted to direct the flow of air into and out of the inner duct 8.

In an embodiment, the cylindrical duct is transversed by a plurality of spokes. Spokes may be fashioned from metal or other materials known in the art and are typically long slender cylindrical objects. Each spoke is attached to the circumference of an inner duct 8 by one of a number of means known in the art. The primary function of the spokes is to maintain proper clearance between the fan and the duct, but also serves to increase the safety of the device by prohibiting large objects from entering the duct. The plurality of spokes 2 are positioned at one or more locations of the device with the fan blade, motor, and motor components positioned inside of the duct, preferentially between spokes 2 at each end of the duct. In an embodiment, each spoke is connected to the central axis 21 and extends radially to the inner duct 8.

In an embodiment, spokes 2 are positioned at each end of the device providing additional support as well as protection of the device at both ends of the duct. This embodiment is useful in an embodiment that allows for rotation of the fan blades to be reversible.

In an embodiment, spokes are also positioned in the middle of the duct, separating two fan blades. In specific embodiment, pluralities of spokes are positioned throughout the duct as deemed useful per the specific application or performance needed.

In a preferred embodiment, the inner duct 8 is encircled by a flexible outer cowling 6, which takes the form of a cylindrical tube around the inner duct 8. The outer cowling 6 is airtight and allows the cowling interior 7 to be filled with gas, such as atmospheric air to provide impact resistance, or a gas such as helium to reduce the apparent weight of the device. The outer cowling 6 may extend part or the entire length of the duct providing maximum protection for the duct to reduce the probability of compromising the structure of the duct and causing rotating fan blades 1 to impact the inner duct 8. The flexible outer cowling is essential for protecting the duct from operation in confined locations as well as “landing” the ducted fan propulsion system on either water or land, ensuring the impact is absorbed and also giving the device the ability to float on water. In a particular embodiment, the outer cowling 6 is removable and replaceable allowing for different ducts to be implemented based on the application of the device and for maintenance and repair.

In an embodiment, the device forgoes the rigid inner duct 8 and utilizes the flexible outer cowling 6 to form both the inner and outer duct. To maintain safety, the space between the inner duct wall and fan blades may increase, however, this may degrade the fan systems performance.

In an embodiment, the outer cowling comprises a sealable aperture, which allows for the input and expulsion of gas or other material into the cavity of the outer cowling 7. This allows for the user to modulate the flexibility, floatation, and aerodynamic properties of the device.

In an embodiment, the outer cowling 6 is constructed from foam. A foam cowling retains the lightweight and shock-absorbent qualities of the device. Further embodiments may include the outer cowling having a hollow core surrounded by foam retaining the ability of the outer cowling to be filled with a gas or other material.

In an embodiment, the outer cowling may be filled with foam beads, providing shock absorption with minimal additional weight being added to the device.

The shape of the outer cowling may significantly impact the fans performance. Aerodynamic properties are altered as a changing pattern in the cowling will alter the flow of air around the ducted fan system. The total weight of the outer cowling may affect the performance of the fan.

In an embodiment, multiple fan blades 1 are positioned inside the duct to provide more power to the unit. Each additional fan blade 1 may require an additional motor to power the blade.

In a particular embodiment, a drag cable 3 is connected to the central axis 21 of the ducted fan. The drag cable 3 is constructed of metal cable, or other materials known in the art and suitable for a specific application of the ducted fan propulsion system. In an embodiment, the drag cable 3 is connected to the rear of the central axis 21 of the ducted fan propulsion system by a swivel connector 9 allowing the ducted fan propulsion system to rotate about the central axis 21. The drag cable 3 is in communication with either the user or various vehicles utilized by the user. The drag cable transmits the force supplied by the ducted fan to the user or vehicle necessitating that the drag cable 3 be strong enough to withstand the force required to mobilize the user or vehicle associated with the device.

In an embodiment, one or more steering cables 4 are positioned at the perimeter of the rigid inner duct 8. In a particular embodiment, two steering cables 4 are positioned on opposing sides of the inner duct, and in communication with a user. The user is able to pull on a steering cable 4 in order to turn the ducted fan, modifying the direction of the force and thus turning the device and user or vehicle in communication with the device. In a particular embodiment, steering cables are connected to the inner duct by a hook-and-loop attachment.

In a preferred embodiment, one steering cable is connected to the bottom center of the circular inner duct, while two steering cables will connect at the top right and top left of the circular inner duct. For example, steering cables will connect at the 6 o'clock, 2 o'clock and 10 o'clock positions in reference to a standard clock. This orientation provides the maximum amount of control with the fewest number of cables.

In an embodiment, power wires 5 are attached to the motor and in communication with an external power source. In a particular embodiment, power wires 5 extend along the one or more steering cables 4 and are in communication with an external power source either positioned on the user or on an external vehicle. Power wires 5 supply necessary power to one or more motors 10 within the ducted fan. In a particular embodiment, power wires 5 are positioned within the spokes 2, providing protection from large objects during use. In an embodiment, the power source is lithium ion, or another lightweight energy storage device.

In an embodiment, a plurality of fan blades 1 are mounted coaxially in the same duct. The plurality of fan blades may rotate in unison, or counter-rotate to account for torque applied by the rotating blades. In an embodiment, the rotational direction of each fan blade is controllable by the user or by a computer, giving further control of the direction of the device.

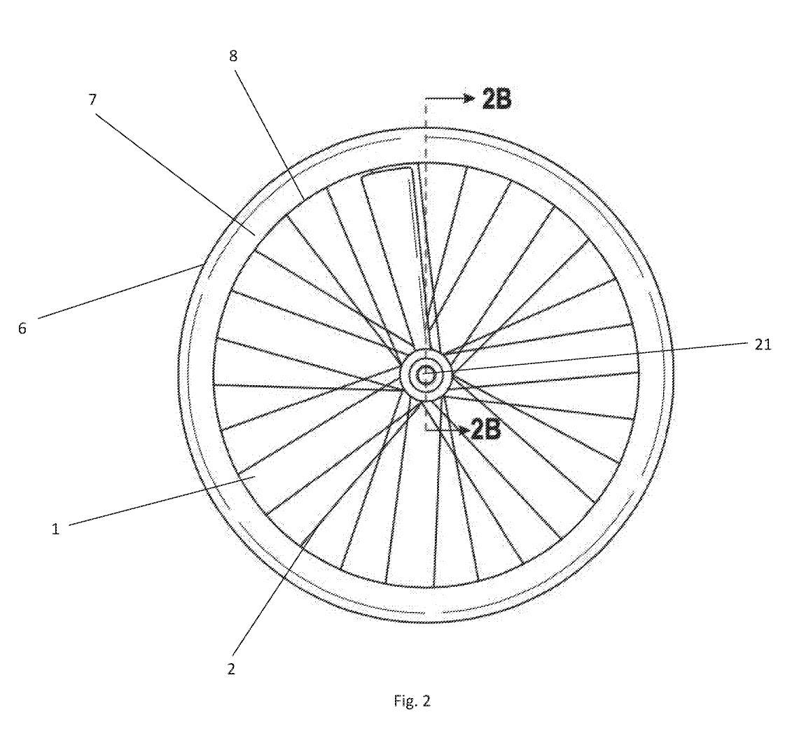

In reference to FIG. 2 the ducted fan propulsion system is shown from a plan view, showing the multitude of spokes 2 protecting the multitude of fan blades 1 within. In a particular embodiment, a multitude of spokes 2 extend from the central axis 21 to the rigid inner duct 8. Spokes 2 are positioned to prohibit large object including debris or body parts from entering the inner duct area containing the rapidly rotating fan blades 1.

Fan blades 1 rotate about the central axis 21 and are oriented to propel air through the duct, providing force necessary for locomotion of the user and optional vehicle attachment.

In a preferred embodiment, the space between the terminal end of the fan blades and the wall of the inner duct is maintained between 0.0005 to 0.25. The shape of the duct may be cylindrical, or modulated to be frustoconical directing and concentrating thrust exerted by the fan blades.

In an embodiment, the spokes as a means of protection may be replaced with a grid. The grid will supply structural support to the device as well as aiding in protecting a user, bystander, or the system itself from damage. The grid may be constructed from numerous materials known in the art. The position of the grid is limited only in its need to protect objects from entering the duct and by the inherent need to maintain airflow through the duct.

In an embodiment, the spokes 2 or grid structure bear the force between the central axis 21 and the inner duct.

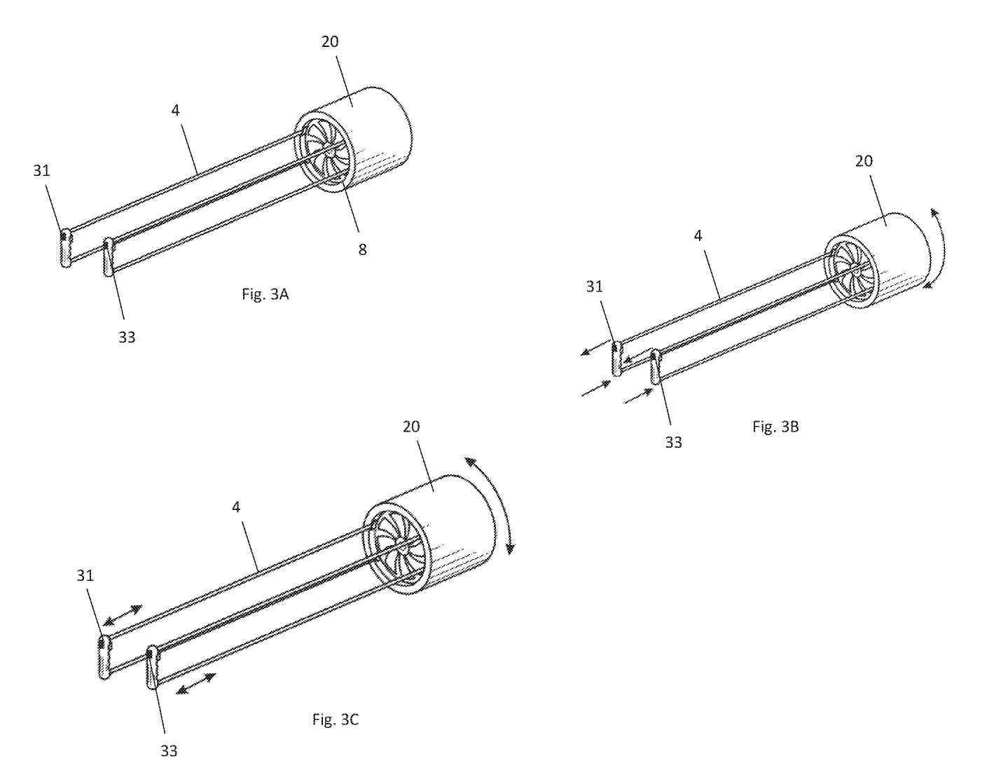

In reference to FIG. 3A, the personal air propulsion system is shown with the ducted fan in communication with a handle 31. The handle 31 may be available in multiple embodiments described herein. In a particular embodiment, the handle 31 has a top and bottom portion with steering cables 4 attached at each end. Each steering cable 4 is in communication with the duct 8 allowing for the user to manipulate the handles and in-turn manipulate the ducted fan to provide lift, turning capabilities, or lower the system.

For example, FIG. 3B shows the handles having the ability to tilt forwards or backwards which in turn will provide lift to the fan. FIG. 3C depicts the user pulling and pushing one of the handles such that the force applied to a side of the ducted fan will allow the user to control yaw of the device. Combinations of these moments may be used in order for the PAPS to have a full range of motion as determined by the user.

In a preferred embodiment, a user, or controlling entity such as computer, has the ability to control the thrust, pitch, roll, and yaw of a fan assembly 20 to have complete control once in use. Acceleration of the device may be controlled by pulling or pushing one or more steering cables or drag wires, or by modulating the thrust output and direction of one or more fan blades in an assembly.

In a particular embodiment, a throttle switch 33 is on the handle allowing the user to control the power output of the PAPS, providing more or less thrust as needed.

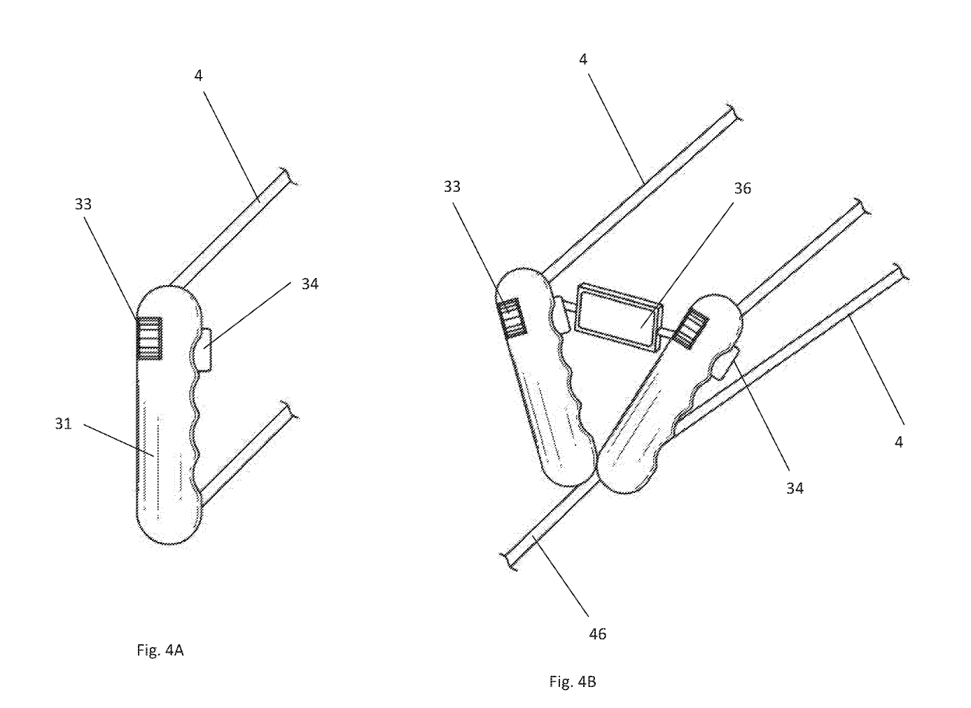

In reference to FIG. 4A an embodiment of the handle is described. In FIG. 4A a particular embodiment, the handle 31 is attached to multiple steering cables 4 allowing for the user to steer the PAPS in communication with the handle. A throttle button 33 is shown as a protruding button giving the user the ability to modulate the power supplied to the motor 10. Power is supplied by power wires 5 extending from the handle and in communication with the motor 10. The throttle button 34 is ergonomically positioned such that the user may easily maintain control of the device as well as the throttle during use.

In an embodiment, each handle is ergonomically designed, having a cylindrical structure with grooves for fingers of the user. Each handle may be constructed of rubber, metal, plastic, or other materials known in the art.

FIG. 4B references an additional embodiment wherein a display screen 36 is positioned between two handles. The display screen 36 may be used to display data received from the PAPS, a camera mounted to the PAPS, or other useful data. In a particular embodiment, handles are position on two sides with the display mounted on a third creating a triangular orientation. In this embodiment, three steering cables may be affixed to the handles in communication with the PAPS. In an embodiment, throttle buttons 34 and throttle switches 33 are positioned on each handle, giving modulatory capabilities to one or fan assemblies, including individual motors 10 or blades 1 within the fan assemblies.

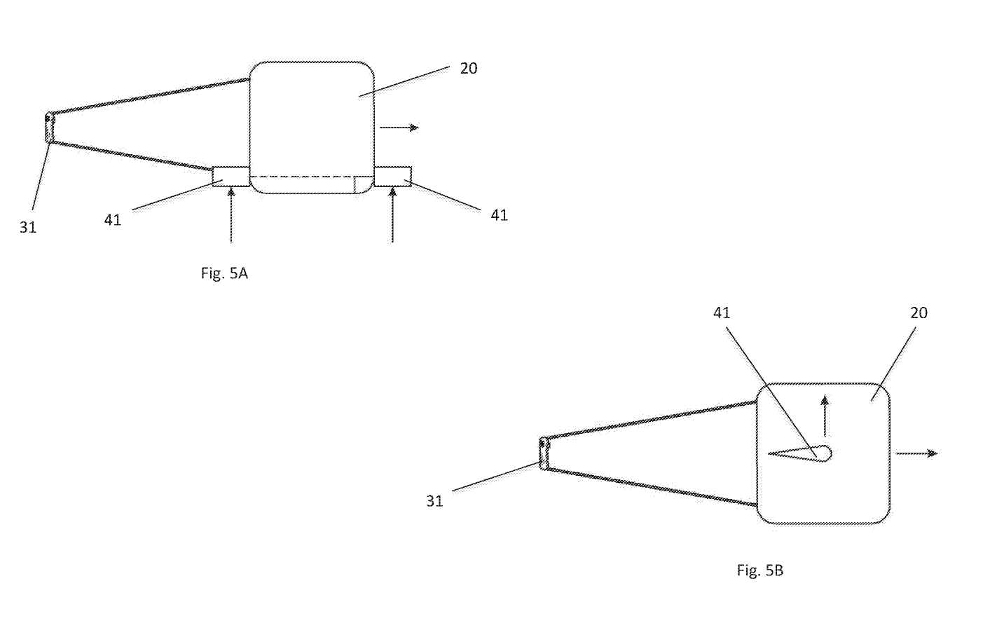

In reference to FIG. 5, an embodiment of the device is shown wherein the ducted fan has auxiliary ducted fans 41 positioned on the exterior allowing for additional control of the device. Referencing FIG. 5A, one or more auxiliary ducted fans 41 are placed at each end—front and back in reference to the user—allowing for control of the pitch of the device, thus raising or lowering the device. In an embodiment, additional power wires 5 are in communication with the user allowing for the user to adjust the power output of the auxiliary ducted fans 41.

Referencing FIG. 5B, auxiliary ducted fans 41 are attached to the duct walls along the side of the ducted fan. In a particular embodiment, the auxiliary ducted fans 41 have the ability to pivot, providing lift to the device. This feature gives the user further control of the device while in use.

As shown, a series of smaller auxiliary ducted fans 41 can be used for “takeoff” and “landing” of the ducted fan propulsion system. The auxiliary ducted fans 41 will preferentially be smaller and steerable by either the handle 31 or a computer as well as other means known in the art. Further, the entire system may have automatic programming capabilities. For example, in the event that the operator lost control, the device may be able to safely land or hover in a controlled manner Auxiliary fans may aid in the overall control and direction of the system by the user with the input of additional control inputs. In one configuration, the auxiliary ducted fans 41 may steer the main fan that would provide the main thrust by taking off and landing vertically with the steering assistance of the smaller fans. It is apparent to one in the art that this system in may apply to other forms of propulsion and not only an electric fan.

In an embodiment, each fan may be controlled from the handle 31 either with additional throttle attachments or by other means known in the art. It is preferential that each auxiliary ducted fan 41 be constructed in a similar fashion to the primary ducted fan, giving the advantage of being lightweight and shock-resistant. Each auxiliary ducted fan 41 may include spokes providing added safety to the device.

In a preferred embodiment, the auxiliary ducted fans are controlled either by a user or by a computer to allow for the device to take-off and land from a level surface in a vertical manner. Take-off and landing with the auxiliary ducted fans arrest the need for forward momentum of the primary fan and tension to supply the forces necessary to elevate the device.

In an embodiment, auxiliary ducted fans 41 have the ability to control the forward and reverse thrust, pitch, roll, and yaw of the fan assembly in order to give the user further control of the device in use. In an embodiment each auxiliary ducted fan has omnidirectional rotational capabilities.

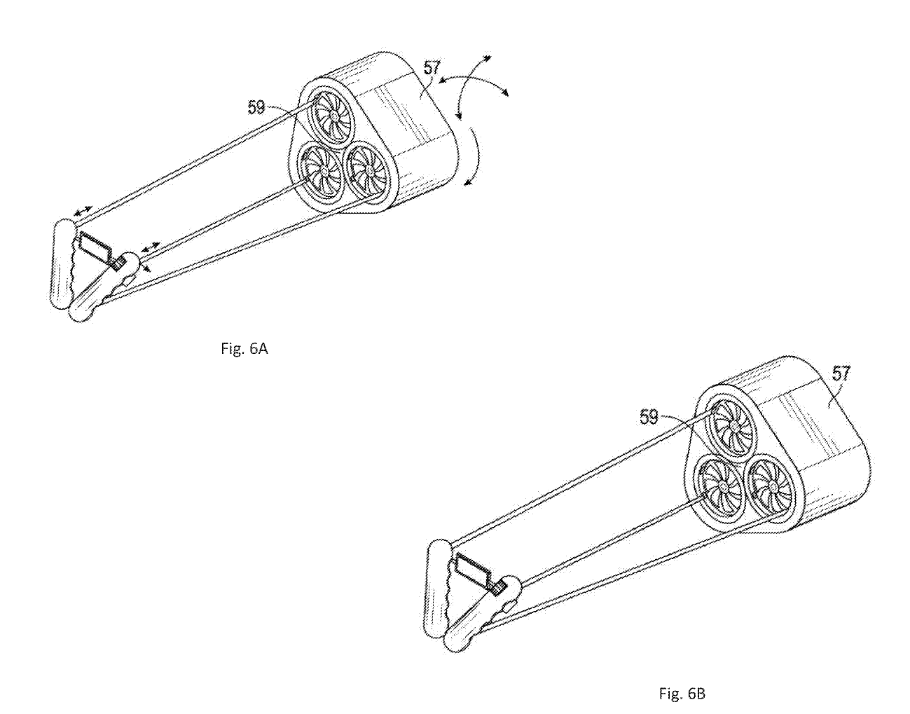

In reference to FIG. 6, an embodiment of the device is shown wherein multiple fans are positioned within a multi-duct casing 57. A multi-duct casing 57 may have the ability to house any number of ducted fans, limited by the ability of the device to remain functional. In an embodiment, three ducted fans are position providing additional power to the device.

In a particular embodiment, three ducted fans are arranged in a triangle. The circular design of the ducted fans positioned within the triangular flexible cowling provide additional space within the flexible cowling for additional lighter-than-air gas giving the necessary floatation needed to maintain functionality of the device. The multi-duct casing and ducted fans within remain in communication with a handle or vehicle as described in previous embodiments and retains the ability to be manipulated by the user to turn, lift, lower, or adjust. In an specific embodiment, a cavity 59 is positioned between ducts allowing for additional gas to be input into the system, reducing the apparent weight of the device.

In an embodiment, the total number of ducted fans is scalable to the power necessary for a given application. A multi-duct casing 57 may be small and utilized as a PAPS or large enough to use in conjunction with a motor vehicle, boat, or aircraft.

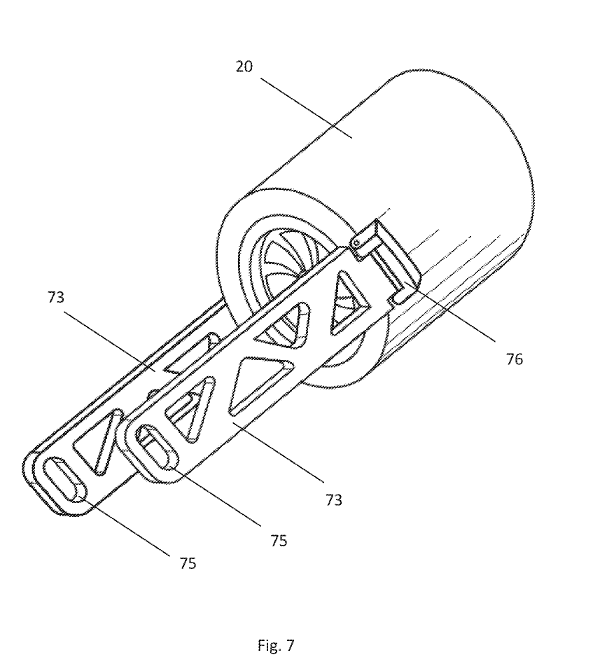

In reference to FIG. 7 a rigid control arm system 73 is shown in communication with the ducted fan assembly 20. The rigid control arm 73 give the operator better control and may provide a plurality of functions including further articulating the control of the device. Further, the rigid control arms 73 may arrest the need of the device to be lightweight, as the control arms may be fixed to a vehicle. This embodiment allows the device to have a fixed elevation, forgoing the need for the user to control this variable.

Further, the rigid control arms 73 may better protect the power cables and steering cables of the device by allowing various cables to be integrated into the structure of the rigid control arms 73 themselves. In a particular embodiment, connection levers 76 may be placed at the connection between the rigid control arm 73 and the ducted fan allowing for the rigid control arms to be easily attached and detached from the ducted fan.

In an embodiment, the rigid control arms are held by the user with one or more integrated handles 75. The integrated handles 75 may contain throttle components or other means of control of the device.

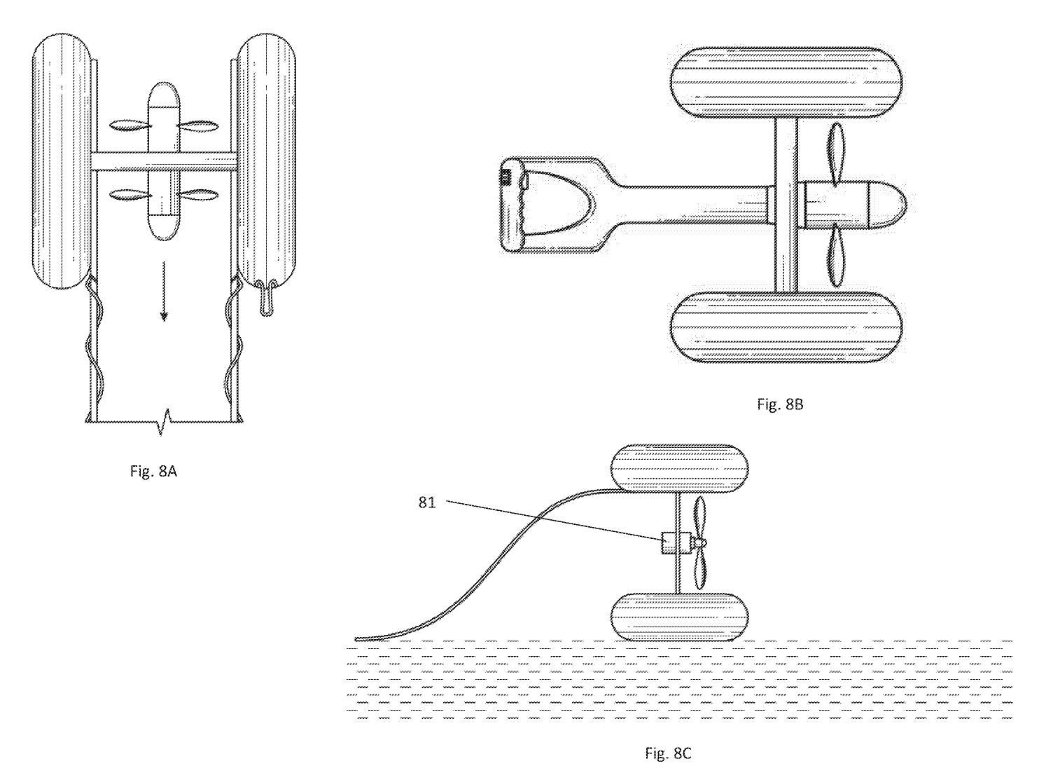

In reference to FIGS. 8A-8C, embodiments of the present invention are shown wherein a water floatation application is made possible. In FIG. 8A, an embodiment is shown wherein the outer cowlings of the device are constructed such that they act as a floatation device for the device, keeping the fan blades and motor components above the water. The particulate embodiment in FIG. 8A the device may be in communication with a personal watercraft, boat, kayak, canoe, waterski, or other watersport devices.

In reference to FIG. 8B, a handheld version of the device is shown wherein the user is able to hold a handle, rigidly connected to the device. FIG. 8C shows a cross section of a PAPS device floating on the surface of the water. Floatation of the device is made possible by the inflated outer cowling.

In an embodiment, the motor components are housed in a waterproof housing 81 allowing for the device to remain operational in water or in inclement weather.

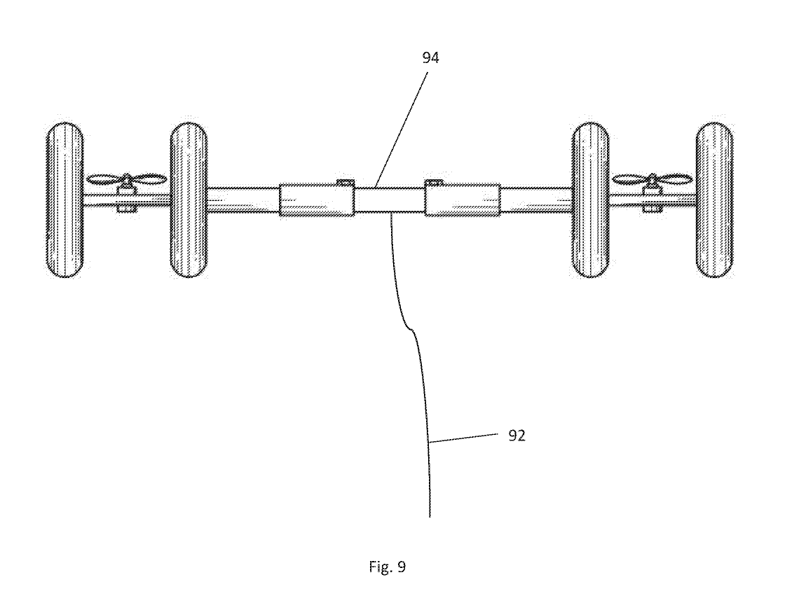

In reference to FIG. 9, a dual assembly embodiment is shown. In a particular embodiment, a connection arm 94 may be placed in between two or more ducted fan systems as described in previous embodiments. The connection arm 94 extends perpendicular to the force applied by the device allowing for more power to be transmitted to the user and moving the exhaust airstream to the sides of the operator.

In an embodiment, the user may hold the connection arm 94 in between the fan assemblies, escaping the output thrust of the ducted fan. In an alternate embodiment, the dual assembly is in communication with a vehicle or user by a tether 92 or other means of attachment.

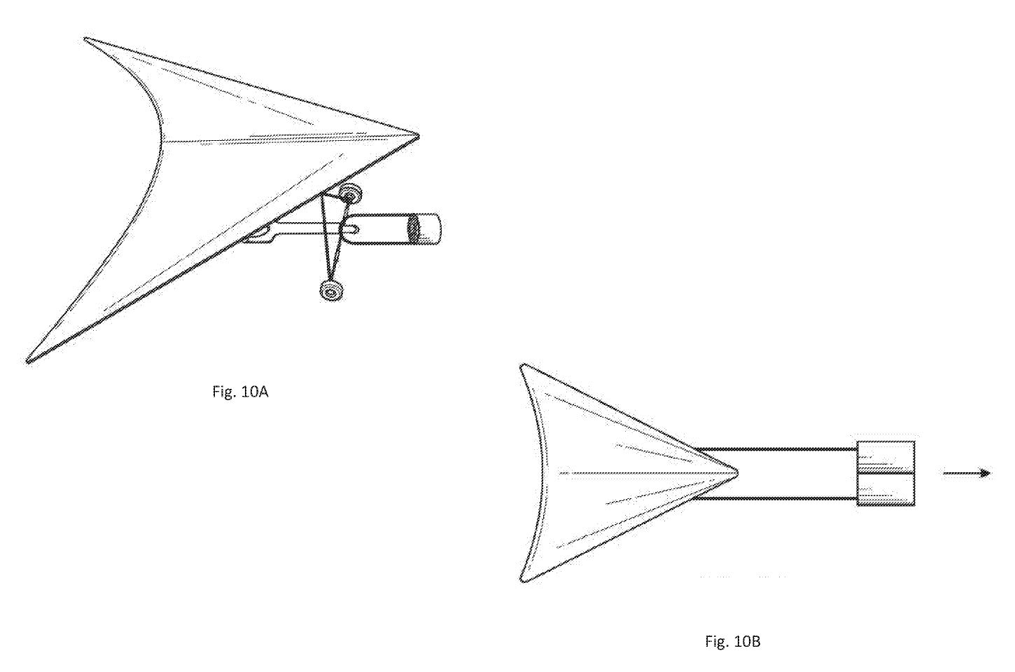

In reference to FIGS. 10A-10B, an application of the PAPS is shown. In the particular embodiment, one or more PAPS's are in communication with a glider providing additional forward force. The PAPS is connected to the glider by drag cables, steering cables, or both. Further, any embodiment of the design may be connected to the vehicle, such as an embodiment wherein a rigid handle is in communication with the fan assembly. Single-ducted or multi-ducted fan assemblies may be utilized in any vehicle embodiment of the device to optimize use of the device.

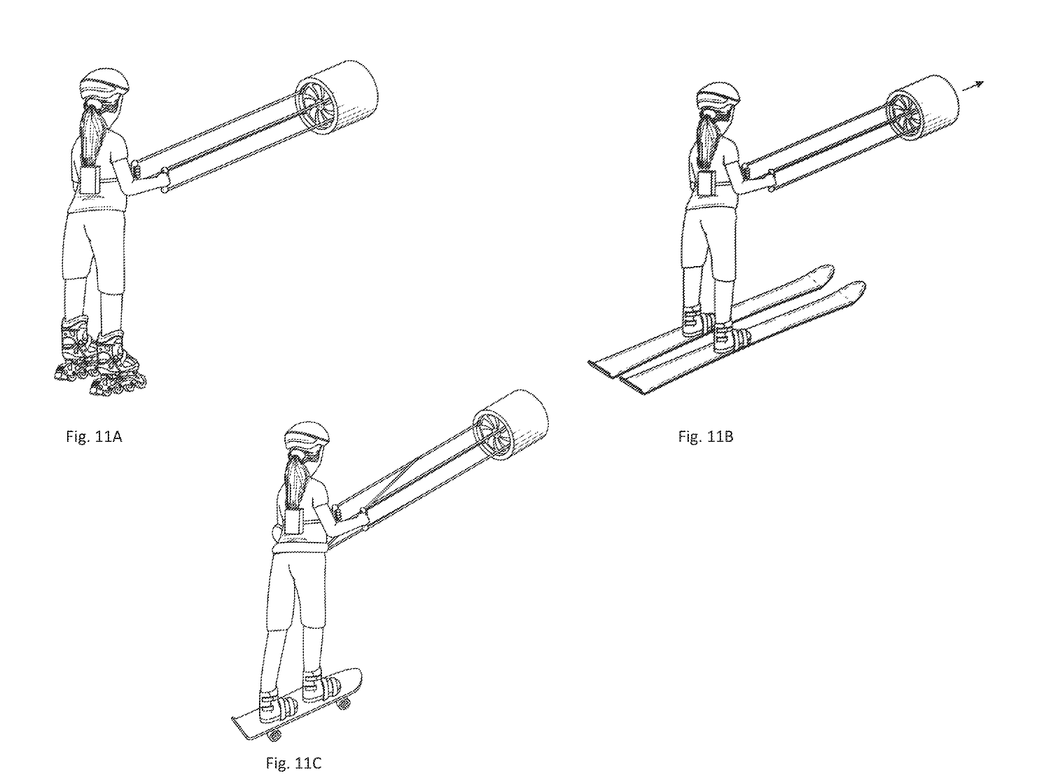

In reference to FIGS. 11A, 11B, and 11C, applications of the PAPS are shown wherein the PAPS is providing a forward force to the user whom is riding various recreational equipment. The user is able to control the device by holding a handle 31 and manipulating the handle to turn, tilt, or rotate the device. A drag cable may be connected to a harness worn y the user, taking the force off of the arms, which may become tired during long periods of use. A throttle button allows the user to control the power output of the motor.

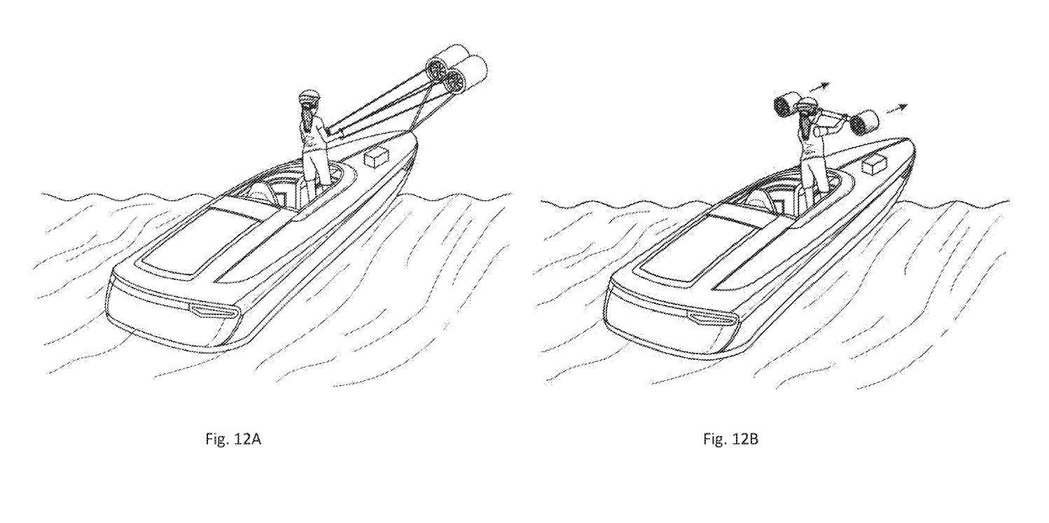

In reference to FIGS. 12A, and 12B, an embodiment of the present invention is shown wherein the PAPS is in communication with a watercraft. FIG. 12A depicts the PAPS attached to the watercraft by multiple drag cables, which bear the force between the PAPS, and the watercraft. This allows the user to easily control the articulation specifically, in FIG. 12B, a handheld version of the PAPS is shown wherein the user is holding a connection arm between multiple ducted fans. One or more throttle buttons may be positioned on the connection arm giving the user control of the power submitted to the PAPS.

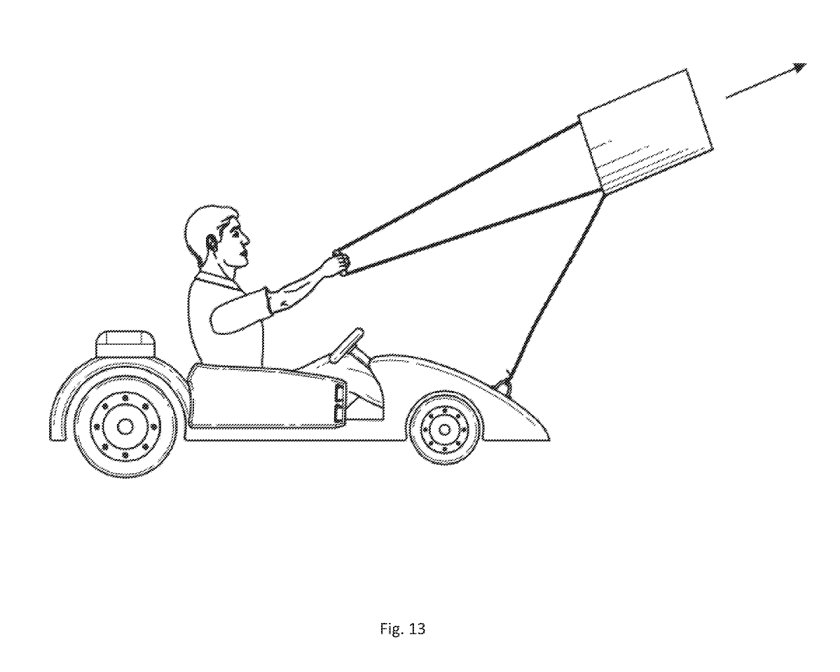

In reference to FIG. 13, the PAPS is in communication with a vehicle. In an embodiment, a drag cable is in communication between the vehicle and the PAPS. The drag cable may be rigid or flexible depending on the specific application and preference of the user. In an embodiment, the user is able to control the PAPS by one more steering cables in connection with a handle.

The invention has been described herein using specific embodiments for the purposes of illustration only. It will be readily apparent to one of ordinary skill in the art, however, that the principles of the invention can be embodied in other ways. Therefore, the invention should not be regarded as being limited in scope to the specific embodiments disclosed herein, but instead as being fully commensurate in scope with the following claims.

I claim:

1. A ducted fan system comprising:
a. an outer cowling adapted to form a duct comprising:
i. one or more rotatable fan blades positioned about a central axis;
ii. one or more motors in communication with the one or more fan blades;
b. one or more members connecting the ducted fan propulsion system to a user.

2. The ducted fan system of claim 1, wherein the duct further comprises;
a. a first and second apertures;
i. the first aperture adapted for air intake; and
ii. the second aperture adapted for air expulsion positioned at the opposing end of the first aperture;
b. a plurality of elements extending between the central axis and the outer cowling.

3. The ducted fan system of claim 1, wherein the one or more motors are in communication with one or more power sources.

4. The ducted fan system of claim 3, wherein the one or more power sources are external.

5. The ducted fan system of claim 1, having an inner duct positioned within the outer cowling.

6. The ducted fan system of claim 1, wherein the outer cowling is hollow.

7. The ducted fan system of claim 6, wherein the outer cowling is adapted to be inflatable.

8. The ducted fan system of claim 1, wherein the outer cowling is a lightweight solid material.

9. The ducted fan system of claim 1, wherein the one or more members are in communication with a vehicle.

10. The ducted fan system of claim 1, wherein the one or more members further comprise;
a. one or more steering cables in communication with the user;
b. one or more drag cables in communication with a user;
c. one or more handles connected to the one or more members further comprising;
i. one or more throttle adjusters protruding from the handle.

11. The ducted fan system of claim 10, wherein the one or more handles are adapted to be held by a user.

12. The ducted fan propulsion system of claim 1, having one or more auxiliary ducted fans.

13. The ducted fan device of claim 1, having the ability to be controlled by a computer system or automatic controller.

14. The ducted fan system of claim 10, wherein the one or more members are rigid.

15. The ducted fan system of claim 10, wherein the handle comprises a mounted display.

16. The ducted fan system of claim 1, having a connection arm attached to one or more ducted fan propulsion systems.

17. The ducted fan propulsion system of claim 1, adapted to be utilized as a drone.

18. The ducted fan propulsion system of claim 1, adapted to be utilized as a lifting fan.

19. A multi-ducted fan system comprising:
a. an outer cowling adapted to form a multitude of ducts each comprising:
i. one or more rotatable fan blades positioned about one or more central axes;
ii. one or more motors in communication with the one or more fan blades;
b. one or more members connecting the multi-ducted fan propulsion system to a user.

20. The multi-ducted fan system of claim 19, wherein each duct further comprises;
a. a first and second apertures;
i. the first aperture adapted for air intake; and
ii. the second aperture adapted for air expulsion positioned at the opposing end of the first aperture;
b. a plurality of spokes extending between the central axis and the outer cowling positioned along the central axis.

21. The multi-ducted fan system of claim 19, wherein the one or more motors are in communication with one or more power sources.

22. The multi-ducted fan system of claim 19, wherein the one or more power sources are external.

23. The multi-ducted fan system of claim 19, having an inner duct positioned within each of the ducts of the outer cowling.

24. The multi-ducted fan system of claim 19, wherein the outer cowling is hollow.

25. The multi-ducted fan system of claim 24, wherein the outer cowling is adapted to be inflatable.

26. The multi-ducted fan system of claim 19, wherein the outer cowling is a lightweight solid material.

27. The multi-ducted fan system of claim 19, wherein the one or more members are in communication with a vehicle.

28. The multi-ducted fan system of claim 19, wherein the one or more members further comprise;
a. one or more steering cables in communication with the user;
b. one or more drag cables in communication with a user;
c. one or more handles comprising connected to the one or more members further comprising;
i. one or more throttle adjusters protruding from the handle.

29. The multi-ducted fan system of claim 28, wherein the one or more handles are adapted to be held by a user.

30. The multi-ducted fan system of claim 19, having one or more auxiliary ducted fans.

31. The multi-ducted fan device of claim 19, having the ability to be controlled by a computer system or automatic controller.

32. The multi-ducted fan system of claim 28, wherein the members are rigid.

33. The multi-ducted fan system of claim 28, wherein the handle comprises a mounted display.

34. The multi-ducted fan system of claim 19, having a connection arm attached to one or more multi-ducted fan propulsion systems.

35. The ducted fan propulsion system of claim 19, adapted to be utilized as a drone.

36. The ducted fan propulsion system of claim 19, adapted to be utilized as a lifting fan.
